(19) United States
(12) Patent Application Publication
(10) Pub. No.: US 2025/0269327 A1
(43) Pub. Date: Aug. 28, 2025

(54) ELECTRO-AMALGAMATION APPARATUS AND METHOD FOR SEPARATING PRODUCT AND NON-PRODUCT LANTHANIDES

(71) Applicant: MCMASTER UNIVERSITY, Hamilton (CA)

(72) Inventors: Matthew D. MORAN, Mississauga (CA); Derek R. MORIM, Hamilton (CA); Andrea F. ARMSTRONG, Hamilton (CA)

(21) Appl. No.: 19/064,114

(22) Filed: Feb. 26, 2025

Related U.S. Application Data
(60) Provisional application No. 63/557,728, filed on Feb. 26, 2024.

(51) Int. Cl. B01D 59/38

(52) U.S. Cl. CPC B01D 59/38

(57) ABSTRACT

An electrochemical cell housing, electro-amalgamation apparatus and method for separating product and non-product lanthanides is provided. The electro-amalgamation apparatus comprises an electrochemical cell with an electrochemical cell housing, where the cell housing comprises an inlet for introducing a substrate into the electrochemical cell for making at least one product. The electrochemical cell comprises an electrochemical cell solution that is held within the cavity and that comprises at least two layers that each have different densities. The electro-amalgamation apparatus comprises an anode element that is at least partially disposed within a lower density layer of the at least two layers, a cathode element that is at least partially disposed within a higher density layer, and a drainage assembly that is coupled to the electrochemical cell for collecting the lower density layer of the at least two layers.

### FIELD OF THE DISCLOSURE

The present disclosure relates generally to methods for separating lanthanides. In particular, the disclosure relates to an electro-amalgamation apparatus and method for separating product and non-product lanthanides.

### BACKGROUND OF THE DISCLOSURE

Lutetium-177 (Lu-177) (t½=6.7 d; Eβ−=0.50 MeV; Eγ=113 keV, 6.4%; 208 keV, 11%) is a radionuclide known for its radiotherapeutic effect when incorporated into radiopharmaceuticals that can treat various cancers, including metastatic prostate cancer, neuroendocrine tumors, and breast cancer. Its properties are ideal in many respects with moderate beta emissions that impart a strong, localized, therapeutic effect, while the low energy, low intensity gamma emissions allow for SPECT imaging. Ytterbium-176 (Yu-176) is the precursor to making no-carrier-added Lu-177, and once irradiated with neutrons inside of a nuclear reactor, is removed from the newly produced Lu-177.

There are advantages and disadvantages to each approach. The carrier-added has a shorter processing time and only the sample is irradiated and dissolved. It also results in Lu-177 contaminated with long-lived Lu-177m (t½=160.4 d) that cannot be separated from Lu-177 and has a specific activity of the Lu-177 (˜5 Ci/mg for research reactor) that is substantially lower than the theoretical maximum value (110 Ci/mg). This means that a smaller proportion of atoms are radioactive, which can affect the distribution of the radioisotope in the body once incorporated into a radiopharmaceutical. Generally, the no-carrier-added version is preferred.

Indirect production of Lu-177 via the Yb-176 avoids formation of Lu-177m while also substantially increasing the specific activity of the Lu-177 to >70 Ci/mg (110 Ci/mg maximum). While the product is preferred, other considerations include the lower cross section of Yb-176 relative to Lu-176, and the need for enriched (and relatively expensive) Yb-176 targets of high purity. Low-purity targets can result in other incidental activation products [Yb-175 (t½=4.2 d, Yb-174 =32.03%) and Yb-169 (t½=32 d, Yb-168 =0.12%)] that can result from impurities.

Currently, no-carrier-added Lu-177 is separated from Yb-176 via ion-exchange chromatography using very large columns to suitably separate the bulk Yb-176. The large columns are used due to the small separation factor between lutetium and ytterbium, as they possess similar chemical properties. While viable, this approach suffers from long processing times, with large volumes of radioactive solvent waste produced.

While both electro-amalgamation and column purification techniques have been reported to separate the Lu-177 from ytterbium, the former has not hitherto been demonstrated to produce material of acceptable quality on a large scale. For chromatographic separation, many of these methods are effective at separating Lu/Yb when the two elements are present in relatively similar concentrations but perform poorly when the Lu/Yb quantities are disproportionate, as is the case when separating Lu-177 (typically <0.5 mg) from neutron-irradiated Yb-176 (typically 0.5-2 g). Thus, to achieve chromatographic separation of Lu-177 from Yb-176, oversized resin columns are used with multiple liters of solvent. While viable, this approach suffers from long processing times, with large volumes of radioactive waste, significant losses of Lu-177 to waste, and poor process reproducibility if the Lu-177 activity per gram of target material varies substantially. Therefore, methods are needed to achieve industry standard specifications for Lu-177 that allow for increased target output on a large scale, reduced waste, and flexibility to accommodate for different starting masses of target.

The background herein is included solely to explain the context of the disclosure. This is not to be taken as an admission that any of the material referred to was published, known, or part of the common general knowledge as of the priority date.

### SUMMARY OF THE DISCLOSURE

According to an aspect, there is provided an electrochemical cell housing, comprising: a metal housing having at least one layer on an interior surface thereof, wherein at least one of said at least one layer comprises at least one polymer.

According to an additional aspect, there is provided an electrochemical cell housing, comprising: a cell container that defines a cavity, an inlet for introducing into the cavity, a substrate for making at least one product, and a drainage assembly, wherein at least a portion of the drainage assembly is positioned within the cavity of the housing for selectively collecting the at least one product from the cavity.

According to another, additional aspect, there is provided an electro-amalgamation apparatus, comprising: an electrochemical cell that comprises: a cell container that defines a cavity, an inlet for introducing into the cavity, a substrate for making at least one product, an electrochemical cell solution that is held within the cavity and that comprises at least two layers that each have different densities, an anode element that is connectable to an external power supply and that is coupled to the cell container such that the anode element is at least partially disposed within a lower density layer of the at least two layers, a cathode element that is connectable to the external power supply and that is coupled to the cell container such that the cathode element is at least partially disposed within a higher density layer of the at least two layers, and a drainage assembly that is coupled to the cell container of the electrochemical cell for collecting the lower density layer of the at least two layers.

According to yet another additional aspect, there is provided a method of separating a product lanthanide and a non-product lanthanide, the method comprising: providing an electrochemical cell that has a solution comprising at least two layers, each of the at least two layers having different densities, introducing the product lanthanide and the non-product lanthanide into the solution of the electrochemical cell, operating the electrochemical cell for separating the non-product lanthanide and a product that comprises the product lanthanide, and collecting a lower density layer of the at least two layers of the solution of the electrochemical cell, wherein the lower density layer of the at least two layers comprises the product solution with the product lanthanide.

It is understood that one or more of the aspects described herein may be combined in any suitable manner. The novel features will become apparent to those of skill in the art upon examination of the following detailed description. It should be understood, however, that the detailed description and the specific examples presented, while indicating certain aspects, are provided for illustration purposes only because various changes and modifications within the spirit and scope of the invention will become apparent to those of skill in the art from the detailed description and claims that follow.

### BRIEF DESCRIPTION OF THE DRAWINGS

Embodiments will now be described, by way of example only, with reference to the attached Figures, wherein:

FIG. 1 is a schematic diagram that shows the process by which Lu-177 can be indirectly produced from Yb-176, and the subsequent decay of the Lu-177;

FIG. 2A is a perspective view of a first embodiment of the electrochemical cell housing of the present disclosure;

FIG. 2B is a section view of the embodiment of the electrochemical cell housing in FIG. 2A, sectioned along line A-A;

FIG. 3A is a perspective view of a second embodiment of the electrochemical cell housing of the present disclosure;

FIG. 3B is a section view of the embodiment of the electrochemical cell housing in FIG. 3A, sectioned along line B-B;

FIG. 4 is a section view of a third embodiment of the electrochemical cell housing of the present disclosure;

FIG. 5A is perspective image of electrochemical cell housing with drainage assembly and the removable anode and cathode elements, 604 in their respective ports;

FIG. 5B is a top view image of the top plate element of the electrochemical cell housing of FIG. 5A;

FIG. 6 is a schematic diagram of an embodiment of the electro-amalgamation apparatus of the present disclosure;

FIG. 7 is an exploded, schematic view of the embodiment of the electro-amalgamation apparatus of FIG. 6;

FIG. 8 is a flow-chart diagram showing the process by which ytterbium-176 is processed to produce the Lu-177 radioisotope;

FIG. 9 is a side view of an embodiment of a glass-walled, water-cooled electrochemical cell housing; and

FIG. 10 is a top view of the glass-walled, water-cooled electrochemical cell housing of FIG. 9.

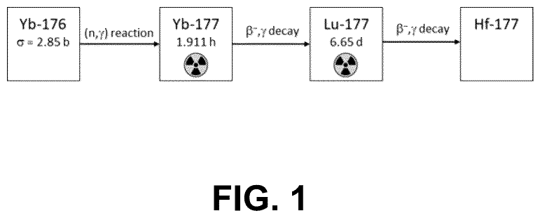

### DETAILED DESCRIPTION OF THE EMBODIMENTS

For simplicity and clarity of illustration, where considered appropriate, reference numerals may be repeated among the Figures to indicate corresponding or analogous elements. In addition, numerous specific details are set forth in order to provide a thorough understanding of the embodiment or embodiments described herein. However, it will be understood by those of ordinary skill in the art that the embodiments described herein may be practiced without these specific details. In other instances, well-known methods, procedures, and components have not been described in detail so as not to obscure the embodiments described herein. It should be understood at the outset that, although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described below.

As used herein, the terms “comprises” and “comprising” are to be construed as being inclusive and open ended, and not exclusive. Specifically, when used in the specification and claims, the terms “comprises” and “comprising,” and variations thereof mean the specified features, steps or components are included. These terms are not to be interpreted to exclude the presence of other features, steps, or components.

As used herein, the terms “about” and “approximately” are meant to cover variations that may exist in the upper and lower limits of the ranges of values, such as variations in properties, parameters, and dimensions.

As used herein, the terms “radioisotopes” and “radionuclides,” refer to atoms in an excited nuclear state that emit radiation as they experience radioactive decay (and can be incorporated into radiopharmaceuticals).

As used herein, the term “radiopharmaceuticals,” refers to radioactive compounds formed by the incorporation of a radionuclide into a pharmaceutical or a pharmaceutical precursor. Such compounds are accepted for use within medical applications including but not limited to nuclear imaging, targeted radionuclide therapy, and similar applications.

As used herein, the term “no-carrier added,” refers to a radioisotope that was prepared, for example, in such a manner that other isotopes of the same target element are not introduced into the product.

As used herein, the term “electro-amalgamation” (EAM), refers to, for example, the use of an electrochemical process consisting of a mercury-pool cathode to achieve separation based on the selective reduction of a non-product lanthanide (e.g. Yb-176) and formation of a non-product lanthanide amalgam (e.g. Yb(Hg)).

Various terms used throughout the present description may be read and understood as follows, unless the context indicates otherwise: “or” as used throughout is inclusive, as though written “and/or”; singular articles and pronouns as used throughout include their plural forms, and vice versa; similarly, gendered pronouns include their counterpart pronouns such that pronouns should not be understood as limiting anything described herein to use, implementation, performance, etc. by a single gender; “exemplary” should be understood as “illustrative” or “exemplifying” and not necessarily as “preferred” over other embodiments. Further definitions for terms may be set out herein; these may apply to prior and subsequent instances of those terms, as will be understood from a reading of the present description. It will also be noted that the use of the term “a” or “an” will be understood to denote “at least one” in all instances unless explicitly stated otherwise or unless it would be understood to be obvious that it must mean “one”.

Modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set.

As used herein, the term “attached” in describing the relationship between two connected parts includes the case in which the two connected parts are “directly attached” with the two connected parts being in contact with each other, and the case in which the connected parts are “indirectly attached” and not in contact with each other but connected by one or more intervening other part(s) between.

As used herein, the terms describing relative positions of elements such as ‘top’, ‘upper’, ‘bottom’, ‘lower’, or other analogous terms will be understood to refer to the placement of the described element during use of the apparatus of which it is a part unless the context would make it clear that it is otherwise. It will be understood that the aforementioned placement of an element, for example, can still be considered its placement even when the object that it is a part of is lying in some position other than the position in which it will be used. As an example, if reference is made to a device having an upper member, it will be understood that the upper member is being described as having an upper position when the device that it is a part of is in use or is in position for use, unless the context would make it clear that it is otherwise. Further to this example, it will be understood that the aforementioned upper member of the object can still be considered its upper member even when the object is lying on its side, for storage, or for transport, or for some other reason.

“Memory” refers to a non-transitory tangible computer-readable medium for storing information (e.g., data or data structures) in a format readable by a processor, and/or instructions (e.g., computer code or software programs or modules) that are readable and executable by a processor to implement an algorithm. The term “memory” includes a single device or a plurality of physically discrete, operatively connected devices despite use of the term in the singular. Non-limiting types of memory include solid-state semiconductor, optical, magnetic, and magneto-optical computer readable media. Examples of memory technologies include optical discs such as compact discs (CD-ROMs) and digital versatile discs (DVDs), magnetic media such as floppy disks, magnetic tapes or cassettes, and solid-state semiconductor random access memory (RAM) devices, read-only memory (ROM) devices, electrically erasable programmable read-only memory (EEPROM) devices, flash memory devices, memory chips and combinations of the foregoing. Memory may be non-volatile or volatile. Memory may be physically attached to a processor, or remote from a processor. Memory may be removable or non-removable from a system including a processor. Memory may be operatively connected to a processor in such a way as to be accessible by a processor. Instructions stored by a memory may be based on a plurality of programming and/or markup languages known in the art, with non-limiting examples including the C, C++, C#, Python™, MATLAB™, Java™, JavaScript™, Perl™, PHP™, SQL™, Visual Basic™, Hypertext Markup Language (HTML), Extensible Markup Language (XML), and combinations of the foregoing. Instructions stored by a memory may also be implemented by configuration settings for a fixed-function device, gate array or programmable logic device.

“Processor” refers to one or more electronic hardware devices that is/are capable of reading and executing instructions stored on a memory to perform operations on data, which may be stored on a memory or provided in a data signal. The term “processor” includes a single device or a plurality of physically discrete, operatively connected devices despite use of the term in the singular. The plurality of processors may be arrayed or distributed. Non-limiting examples of processors include integrated circuit semiconductor devices and/or processing circuit devices referred to as computers, servers or terminals having single or multi-processor architectures, microprocessors, microcontrollers, microcontroller units (MCU), central processing units (CPU), field-programmable gate arrays (FPGA), application specific circuits (ASIC), digital signal processors, and combinations of the foregoing.

Any method, application or module herein described may be implemented using computer readable/executable instructions that may be stored or otherwise held by a memory and executed by a processor. Aspects of the present disclosure may be described with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor, such that the processor, and a memory storing the instructions, which execute via the processor, collectively constitute a machine for implementing the functions/acts specified in the flowchart and/or block diagram block or blocks.

The flowcharts and functional block diagrams in the figures illustrate the architecture, functionality, and operation of possible implementations of systems, methods, and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The embodiments of the disclosure described herein are exemplary (e.g., in terms of materials, shapes, dimensions, and constructional details) and do not limit by the claims appended hereto and any amendments made thereto. Persons skilled in the art will appreciate that there are yet more alternative implementations and modifications possible, and that the following examples are only illustrations of one or more implementations. The scope of the disclosure, therefore, is only to be limited by the claims appended hereto and any amendments made thereto.

As used herein, the term “product lanthanide” refers to a lanthanide or lanthanoid element that is the desired target of the separation process as provided by the presently disclosed method, while the term “non-product lanthanide” refers to a lanthanide or lanthanoid element that is to be separated from the “product lanthanide” and is not the target of the separation process. In the present disclosure, prior to the separation process, the “product lanthanide” and “non-product lanthanide” may be both contained in a mixture, where the mixture may be of any origin. The term “product lanthanide” refers to a target lanthanide within the mixture and the “non-product lanthanide” refers to a non-target lanthanide that exists as, for example, an impurity in the mixture.

In the present disclosure, the term “non-product lanthanide” may refer to a different lanthanide that is present within the mixture, and the term “product lanthanide” may refer to a single lanthanide isotope that can be separated from the mixture such that the lanthanide is a no-carrier added lanthanide (e.g. the product lanthanide is a single isotope and is substantially free of the unwanted lanthanides and carrier lanthanides).

In some embodiments of the present disclosure the product lanthanide is lutetium (Lu), and the non-product lanthanide is ytterbium (Yb).

In an additional embodiment of the present disclosure, the product lanthanide is the radionuclide ¹⁷⁷Lu, the non-product lanthanide is ¹⁷⁶Yb, and the mixture consists of the product and non-product lanthanides as a result of the neutron irradiation. The irradiated mixture may be generated by applying neutron irradiation to the ¹⁷⁶Yb, preferably enriched ¹⁷⁶Yb, and allowing the target to decay to produce ¹⁷⁷Lu via beta-decay of the short-lived radioisotope ¹⁷⁷Yb.

The present disclosure provides an electrochemical cell housing 100, an electro-amalgamation apparatus 600 that comprises an electrochemical cell 320 and the electrochemical cell housing 100, and a method of using the electro-amalgamation apparatus 600 for separating the product lanthanide and the non-product lanthanide.

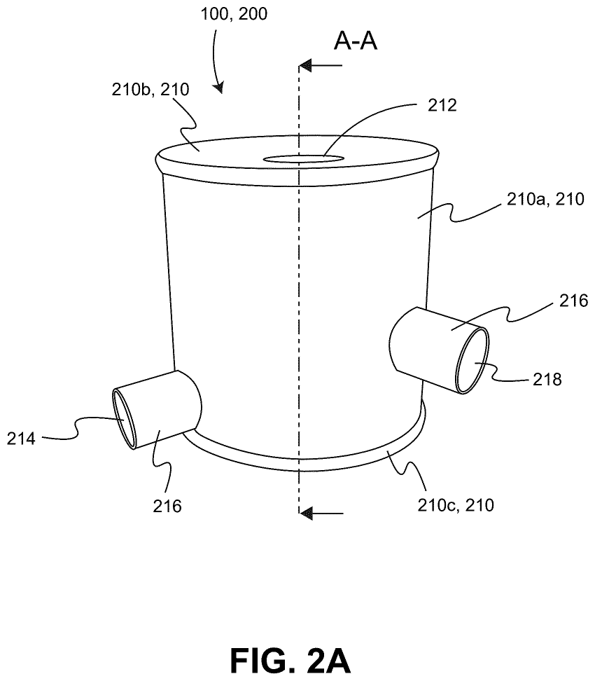

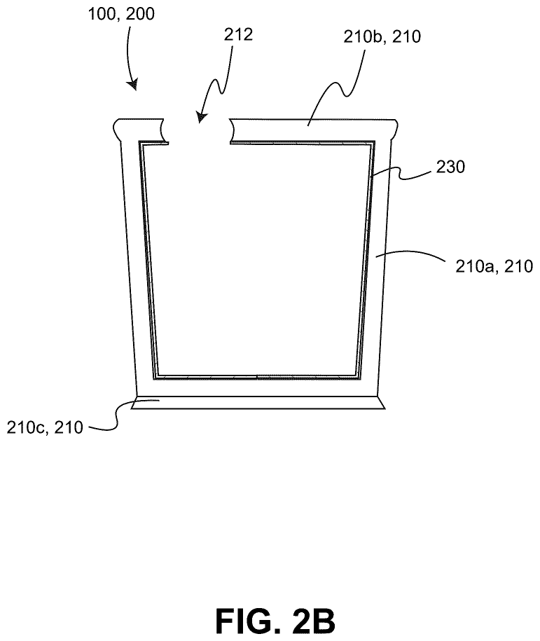

Referring to FIGS. 2A and 2B, a first embodiment of the electrochemical cell housing 100 is shown as the electrochemical cell housing 200. The electrochemical cell housing 200 comprises a metal housing 210 having at least one layer 230 on an interior surface thereof, where at least one of said at least one layer 230 comprises at least one polymer. Said another way, the electrochemical cell housing 200 is structured as a metal housing 210 that comprises one or more interior layers 230, one of which is composed of at least one polymer.

The at least one interior layer 230 of the electrochemical cell housing 200 may be disposed on the at least one interior surface of the metal housing 210 by various means. In one embodiment, the at least one interior layer 230 is applied as a coating that is applied directly onto the at least one interior surface of the metal housing 210. In an alternate embodiment, the at least one interior layer 230 is provided as at least one solid layer that is adhered onto the at least one interior surface of the metal housing 210. The at least one polymer of said at least one layer is generally selected to have an electrical resistivity of at least 1010 ohm·cm and to have a high dielectric strength such that the at least one polymer of the at least one interior layer 230 may not experience substantial breakdown due to the presence of electric fields in proximity to the electrochemical cell housing 200.

In an embodiment, the electrochemical cell housing 200 is structured such that the at least one polymer of said at least one layer comprises an insulating polymer for inhibiting any reaction of the metal housing 210.

In an additional embodiment, the insulating polymer of said at least one layer 230 includes at least one of an epoxy, a silicone, a polyethylene, a polypropylene, a polyethylene terephthalate, a fluoropolymer, or a combination thereof, but may extend to any suitable polymer. Examples of other suitable polymers include those polymers that exhibit high dielectric performance, and which can endure the condition(s) within the cell. For example, the polymers may not exhibit substantial breakdown (e.g., chemical, or physical).

In an exemplary embodiment, the at least one polymer is an epoxy-based polymer and said at least one layer comprises a layer of a coating of the epoxy-based polymer.

In another exemplary embodiment, the at least one polymer is an epoxy-based polymer and said at least one layer comprises a layer of a 2-part epoxy coating (TE Expert).

In an embodiment, the metal housing 210 comprises at least one metal material. In some embodiments, the at least one metal material comprises metal(s), metal alloy(s), or a combination thereof. Some examples of these include aluminum, steel, or a combination thereof. In further embodiments, the at least one metal material may be selected to have a thermal conductivity that is greater than 30 W/mK.

In an additional embodiment, the metal housing 210 of the electrochemical cell housing 200 comprises at least two apertures. A first aperture of the at least two apertures is structured for introducing a substrate for making at least one product into the metal housing 210, and a second aperture of the at least two apertures is structured for collecting the at least one product from the electrochemical cell 320. In this way, the at least two apertures of the metal housing 210 can be said to define at least one inlet 212 and at least one outlet of the metal housing 210.

In an embodiment such as shown in FIG. 2B, the metal housing 210 of the electrochemical cell housing 200 comprises a metal, hollow, substantially cylindrical cell body 210a, a top plate element 210b that is connected to a first end of the cell body 210a, and a bottom plate element 210c that is connected to a second end of the cell body 210a opposite the first end of the cell body 210a.

In an additional embodiment, the top plate element 210b of the metal housing 210 comprises the first aperture that defines the at least one inlet 212 of the electrochemical cell housing 200, and the bottom plate element 210c comprises the second aperture that defines the outlet of the electrochemical cell housing 200.

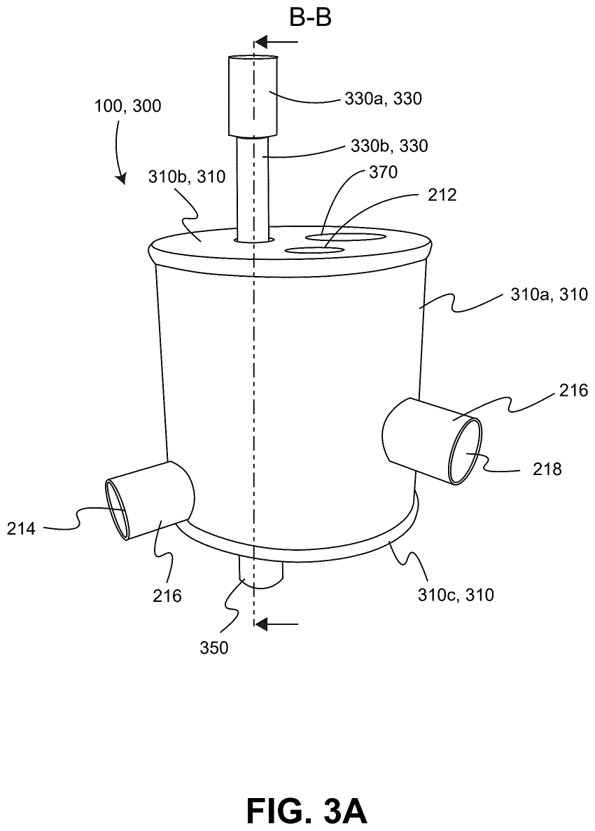

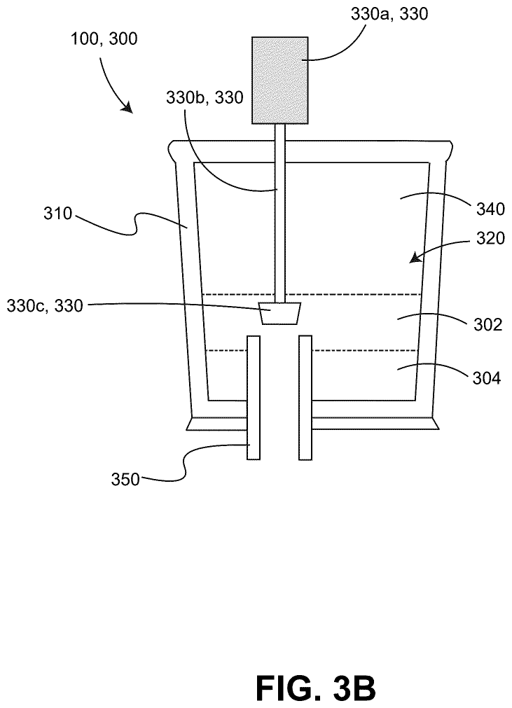

Referring to FIGS. 3A and 3B, a second embodiment of the electrochemical cell housing 100 of the present disclosure is provided as the electrochemical cell housing 300. The electrochemical cell housing 300 comprises a cell container 310 that defines a cavity 340. The cell container 310 also comprises an inlet for introducing into the cavity 340, a substrate for making at least one product, and a drainage assembly 350. At least a portion of the drainage assembly 350 is positioned within the cavity 340 of the housing for selectively collecting the at least one product from the cavity 340. As shown in FIG. 3B, the drainage assembly 350 generally comprises at least one drainage conduit. The drainage assembly 350 also comprises at least one actuator 330 that is operably connected to the drainage conduit to control the collection of the at least one product via the drainage conduit.

The actuator 330 is actuatable between an engaged position where the actuator 330 seals off the inlet end of the drainage conduit, and an unengaged position where the actuator 330 separates from the inlet end of the drainage conduit such that the drainage conduit is substantially open to allow fluid flow therethrough.

The drainage conduit of the drainage assembly 350 can be composed over various material and made through various fabrication processes. In an exemplary embodiment, the drainage conduit is fabricated via a 3-D printing process and is composed of a PET-g plastic material that is chemically inert to the substrate and the at least one product that can be contained within the cavity 340 of the cell container 310.

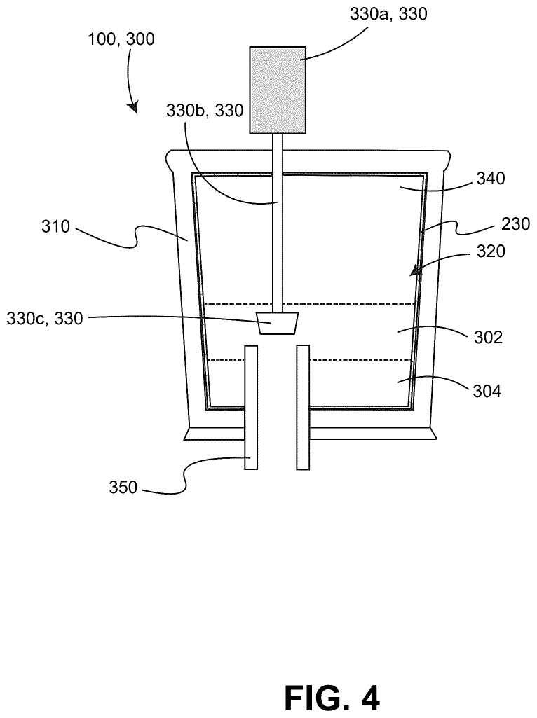

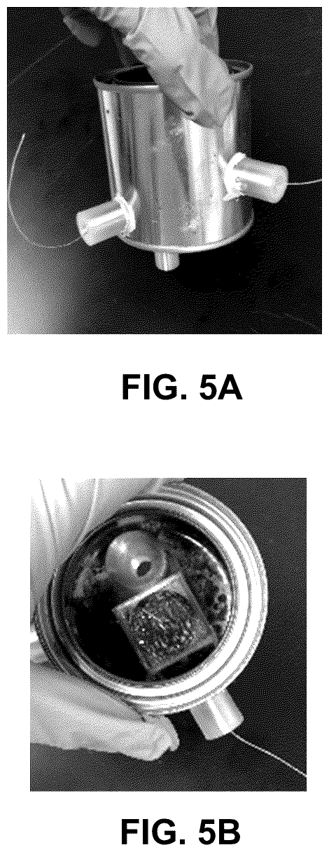

In an embodiment such as shown in FIG. 4, the electrochemical cell housing 100 is structured as an electrochemical cell housing 400 that comprises all the aforementioned elements of both the electrochemical cell housing 200 and the electrochemical cell housing 300. In this embodiment, the cell container 310 of the electrochemical cell housing 300 is structured as the metal housing 210 of the electrochemical cell housing 200 such that the metal housing 210 defines the cavity 340.

The present disclosure also provides for the electrochemical cell 320, where the electrochemical cell 320 comprises the electrochemical cell housing 100 in the form of one of the electrochemical cell housing 200, the electrochemical cell housing 300, and the electrochemical cell housing 400.

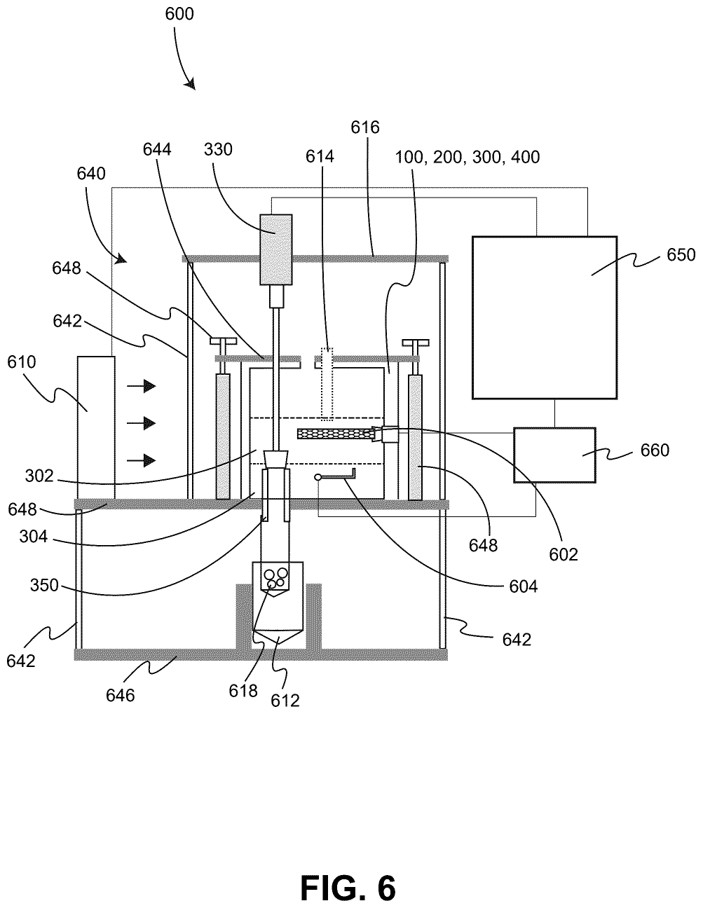

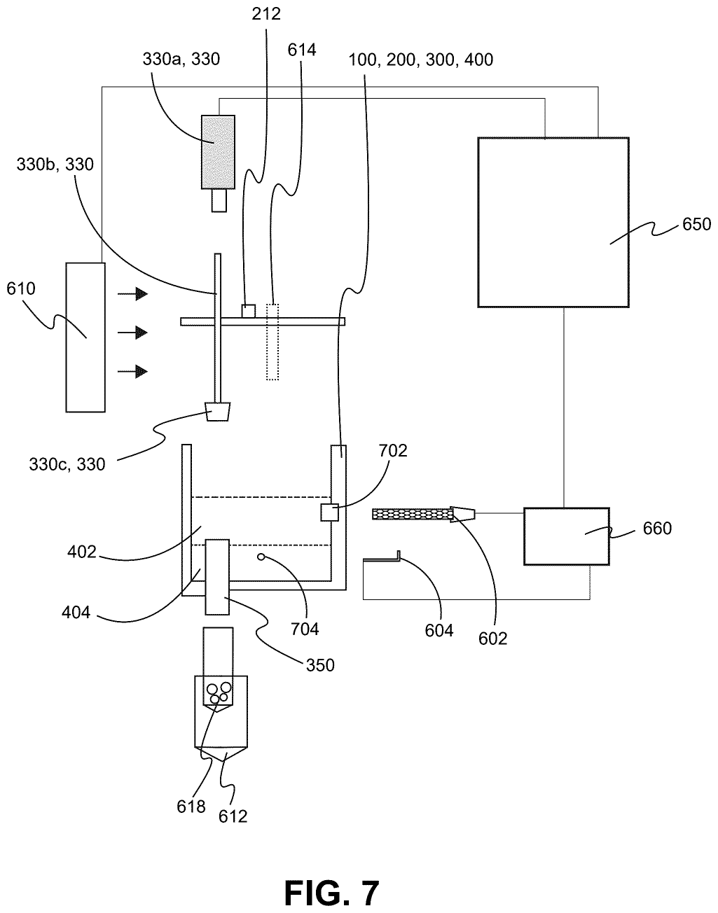

In an additional embodiment of the electrochemical cell 320 that comprises the one of the electrochemical cell housing 100 in the form of one of the electrochemical cell housing 200, electrochemical cell housing 300, or electrochemical cell housing 400, the electrochemical cell 320 further comprises an anode element 602 that is connectable to an external power supply 660 and that is coupled to the electrochemical cell housing 100, and a cathode element 604 that is connectable to the external power supply 660 and that is coupled to the electrochemical cell housing 100 (see FIG. 6). As shown in FIGS. 6 and 7, the anode element 602 that is connectable to the external power supply 660 is at least partially disposed within the cavity 340 of the electrochemical cell housing 100, and the cathode element 604 that is connectable to the external power supply 660 is at least partially disposed within the cavity 340 of the electrochemical cell housing 100.

In an embodiment, the cathode element 604 is removably mounted to the electrochemical cell housing 100 via a cathode holder 704 that is fixedly mounted through the electrochemical cell housing 100.

In an additional embodiment, the cathode element 604 comprises at least one metallic wire. The at least one metallic wire may be made from any suitable metal, metal alloy, or a combination thereof. Some examples include platinum, platinum-coated metals, other inert electrode material(s), or a combination thereof. In particular embodiments, the inert electrode material is selected as a material that does not form amalgams with mercury.

In the specific embodiment provided in FIGS. 6 and 7, the cathode holder 704 comprises a stopper element 330c that is mounted through an opening in the cell container 310 and which fluidly seals off the opening when mounted therewithin. The at least one metallic wire of the cathode element 604 is fed through the stopper element 330c, thereby allowing the electrodes to be removed for cleaning if the electrochemical cell housing 100 is to be reused.

In an embodiment, the anode element 602 is removably mounted to the electrochemical cell housing 100 via an anode holder 702 that is fixedly mounted through the electrochemical cell housing 100. The anode holder 702 is structured to inhibit the rotation of the anode element 602 relative to the cavity 340 of the cell container 310 during electro-amalgamation within the cavity 340 of the cell container 310.

In an additional embodiment, the anode element 602 comprises a metallic mesh and the metallic mesh is held within the anode holder 702. For example, the metallic mesh is composed of at least one metal. Some examples of the at least one metal include platinum, platinum-coated metals, other inert electrode material(s), or a combination thereof. In particular embodiments, the inert electrode material is selected as a material that does not form amalgams with mercury. The size of the metallic mesh of the anode element 602 can be varied depending on the specifics of the electrochemical cell 320 and electrochemical cell solution. Generally, larger meshes can increase the current delivered via the anode element 602 (though this effect is not linear with respect to surface area) but the temperature within the electrochemical cell 320 should be regulated in order to limit overheating due to the increased current delivery. For example, the use an anode element 602 that is a platinum wire fitted mesh with a 6.25 cm² surface area may generate only half as much current in comparison to an anode element that is a Pt gauze (2.5×2.5 cm, 52 mesh) with a surface area of 25 cm² and may achieve only half the initial rate of non-product lanthanide removal compared to the Pt gauze. However, the higher current generated via the Pt gauze can be accompanied by an increase in the amount of organic residue from citrate oxidation and/or the increased temperature of the anode element 602.

In an additional embodiment, the metal housing 210 of the electrochemical cell housing 200 and the cell container 310 of the electrochemical cell housing 300 each comprises a pair of through-openings 214, 218 formed along a sidewall thereof. Each of the pair of through-openings 214, 218 is sized to retain one of the anode element 602 and the cathode element 604 therethrough such that the anode and cathode elements 602, 604 are at least partially disposed within the metal housing 210 or within the interior cavity 340 of the cell container 310.

In the specific embodiment provided in 2A, 3A and 5A, the cylindrical cell body 210a of the metal housing 210 (and also the cell container 310) comprises a pair of tubular bodies 216 that extends outward from an outer surface of the metal housing 210 and/or cell container 310. Each of the pair of through-openings is formed through one of the pair of tubular bodies 216.

In some embodiments, the tubular bodies 216 are integrally formed with the metal housing 210. In an alternate embodiment, the tubular bodies 216 are separate components from the metal housing 210 and are mounted to the metal housing 210 via a mounting means such as welding, epoxy, or fastener elements.

Some embodiments of the present disclosure provided for the electrochemical cell 320 that comprises the electrochemical cell housing 100. The present disclosure also provides for an electro-amalgamation apparatus 600 that comprises the electrochemical cell 320. In a first embodiment of the electro-amalgamation apparatus 600, the electro-amalgamation apparatus 600 comprises the electrochemical cell 320, and the electrochemical cell 320 comprises the electrochemical cell housing 200. In an alternate embodiment of the electro-amalgamation apparatus 600, the electro-amalgamation apparatus 600 comprises the electrochemical cell 320, and the electrochemical cell 320 comprises the electrochemical cell housing 300. In another alternate embodiment, the electro-amalgamation apparatus 600, the electro-amalgamation apparatus 600 comprises the electrochemical cell 320, and the electrochemical cell 320 comprises the electrochemical cell housing 400.

In an additional embodiment where the electro-amalgamation apparatus 600 comprises either the electrochemical cell housing 200 or the electrochemical cell housing 400, the electro-amalgamation apparatus 600 further comprises a fluid driving element 610 that is structured to pass cooled air over the electrochemical cell housing 200/electrochemical cell housing 400 for cooling the electrochemical cell 320 that is held within the cell housing 200/electrochemical cell housing 400.

By passing the cooled air over the electrochemical cell housing 200/electrochemical cell housing 400 that comprises the metal housing 210, the electrochemical cell 320 and electro-amalgamation apparatus 600 that contains the electrochemical cell 320 can achieve a comparable or higher removal of non-product lanthanides from the substrate when compared to an electro-amalgamation apparatus 600 that comprises an electrochemical cell with glass housing. Providing the electrochemical cell housing 200, 400 that is at least partially composed of a polymer-coated metal enables efficient air-based cooling, and as such the electro-amalgamation apparatus 600 does not have to use a traditional, water-cooled electrochemical cell. Given the challenges associated with introducing water-cooling into hot cells for radioactive processing, providing an electro-amalgamation apparatus 600 that does not have to include this feature, makes the implementation and use of the electro-amalgamation apparatus 600 substantially more straightforward.

In the specific embodiment provided in FIGS. 6 and 7, the fluid driving element 610 is at least one fan that is positioned on the support structure to direct cooled air over the electrochemical cell housing 200/electrochemical cell housing 400.

In an exemplary embodiment, the fan of the electro-amalgamation apparatus 600 is direct-current operated, MS1751M24B FHR type Mechatronics Fan.

In an embodiment, the substrate for making the at least one product is formed as an initial reaction solution.

In an embodiment where the substrate is the initial reaction solution, the initial reaction solution comprises the product lanthanide and the non-product lanthanide.

In an additional embodiment where the substrate is the initial reaction solution, the initial reaction solution comprises the product lanthanide, the non-product lanthanide, and an acidic solution.

In another additional embodiment, the product lanthanide in the initial reaction solution is ¹⁷⁷Lu and the non-product lanthanide in the initial reaction solution is ¹⁷⁶Yb.

The electrochemical cell 320 within the housing is generally formed to receive the substrate that is introduced via said inlet of the at least two apertures. The electrochemical cell 320 is also structured to include an electrochemical cell solution, where the electrochemical cell solution is held within the cavity 340 of the cell container 310 and comprises at least two layers that each have different densities. As shown in FIGS. 4, 6 and 7, the at least two layers of the electrochemical cell solution include a lower density layer 302 and a higher density layer 304 that is disposed below the lower density layer 302.

In an additional embodiment, the higher density layer 304 of the at least two layers comprises mercury.

In another, additional embodiment, the lower density layer 302 of the at least two layers comprises a solution of at least one alkali metal salt.

In the embodiments where the electrochemical cell housing 100 of the electrochemical cell is the electrochemical cell housing 300, the anode and cathode elements 602, 604 are connected through the electrochemical cell housing 300 such that the anode and cathode elements 602, 604 are specifically positioned relative to the at least two layers of the solution in the electrochemical cell 320. As shown in FIGS. 6 and 7, the anode and cathode elements 602, 604 are mounted through the cell housing such that the anode element 602 is at least partially disposed within the lower density layer 302 of the at least two layers, and the cathode element 604 is at least partially disposed within the higher density layer 304 of the at least two layers.

The substrate (in the form of the initial reaction solution) is generally mixed with the solution of at least one alkali metal salt to form a primary reaction solution. In the embodiment where the substrate is the initial reaction solution, the primary reaction solution comprises the initial reaction solution and the solution of the at least one alkali metal salt. In an exemplary embodiment of the primary reaction solution, the solution comprises the non-product lanthanide in the form of Yb-176, the product lanthanide in the form of Lu-177, the alkali metal salt solution, and the acidic solution.

In yet another additional embodiment, the alkali metal salt solution is in the form of a lithium citrate solution and the acidic solution is a solution of hydrochloric acid.

In some embodiments, the solution of at least one alkali metal salt is included in the electrochemical cell 320 as part of the lower density layer 302 of the at least two layers and the substrate is introduced into the cavity 340 of the cell container 310 such that substrate can mix/combine with one or more layers of the at least two layers to form a layer of the at least two layers that is a primary reaction solution.

In an alternate embodiment, the solution of at least one alkali metal salt is combined with the initial reaction solution (i.e., substrate) to form the primary reaction solution prior to introducing the primary reaction solution into the cavity 340. In this way, the primary reaction solution (i.e., substrate) can form the lower density layer 302 of the at least two layers once introduced to the cavity 340 of the cell container 310.

The electrochemical cell 320 as disclosed herein can be applied as part of the electro-amalgamation apparatus 600 (described in more detailed below) in order to facilitate the separation of the product lanthanide and the non-product lanthanide in the primary reaction solution via at least one electro-amalgamation step.

The initial reaction solution comprises the product lanthanide and non-product lanthanide. The least one product that forms from the separation of the primary reaction solution via the electro-amalgamation step comprises a product solution that comprises the product lanthanide, and also comprises an amalgam of the non-product lanthanide. The electro-amalgamation step occurs such that the product solution that has the product lanthanide remains substantially contained within the lower density layer 302 of the at least two layers of the solution of the electrochemical cell 320, while the amalgam of the non-product lanthanide is substantially disposed in the higher density layer 304 of the at least two layers.

The use of such an electro-amalgamation process is more effective than chromatography at separating large masses of non-product lanthanide from small masses of product lanthanide (disproportionate masses) and the process uses less liquids, resulting in less radioactive waste.

In an additional embodiment, the drainage assembly 350 is coupled to the cell container 310 of the electrochemical cell 320 for selectively collecting the lower density layer 302 of the at least two layers prior to any removal of the other layers of the at least two layers. By structuring the drainage assembly 350 to remove just the lower density layer 302 of the at least two layers first, the drainage assembly 350 can rapidly remove the at least one product of the electro-amalgamation step after the formation of the at least one product. In the embodiments where the initial reaction solution comprises the product lanthanide and the non-product lanthanide, the structure of the drainage assembly 350 as described allows for the lower density layer 302 to be drained first, thereby reducing the amount of time that the product solution that comprises the product lanthanide will be in contact with the non-product lanthanide amalgam. The longer the product lanthanide solution is in contact with the non-product lanthanide amalgam, the more that the non-product lanthanide will be gradually released back into the solution once the electrical current from the external power supply is turned off. By providing a drainage assembly 350 that facilitates the rapid removal of the lower density layer 302 (containing the product solution) via the drainage assembly 350, a comparable or higher rate of removal of the non-product lanthanide can be achieved, as there is less time for the non-product lanthanide to be released back into the product lanthanide solution.

In an embodiment such as shown in FIG. 3B, 4 and 6, the drainage assembly 350 comprises the drainage conduit, and the drainage conduit is mounted through the cell container 310 such that an inlet of the drainage conduit is disposed in a lower density layer 302 of the at least two layers of the solution of the electrochemical cell 320.

In an additional embodiment, the drainage assembly 350 further comprises the actuator 330, and the actuator 330 is operably connected to the drainage conduit and is actuatable to selectively close and open the drainage conduit for collecting at least the lower density layer 302 of the at least two layers.

In an additional embodiment, the actuator 330 is structured as a linear actuator 330.

In an additional embodiment, a height (h) of an inlet end of the drainage conduit within the cell cavity 340 is selected based on a height to the at least two layers of the solution of the electrochemical cell 320 within the cavity 340 of the cell container 310.

In an additional embodiment, the drainage assembly 350 comprises a height adjustment actuator 330 for varying the height (h) of the inlet of the drainage conduit. The height adjustment actuator 330 is connected between the drainage conduit and the electrochemical cell housing 100 to facilitate the variation of the height (h) of the inlet of the drainage conduit within the cavity 340. By providing the drainage assembly 350 with the height adjustment actuator 330, the height of the inlet of the drainage conduit can be varied for differing heights of the at least two layers of the solution within the cavity 340 such that the inlet of the drainage conduit is disposed within the lower density layer 302 of the at least two layers.

In an embodiment such as shown in FIGS. 6 and 7, the actuator 330 of the drainage assembly 350 is mounted through the top plate element 210b of the housing and extends down through the cavity 340 to operably engage the drainage conduit of the drainage assembly 350.

In the specific embodiment provided in FIGS. 6 and 7, the actuator 330 assembly comprises an actuating element 330a and an actuator rod 330b with opposing first and second ends. The first end of the rod 330b is connected to the actuating element 330a and the second end comprises a stopper element 330c that is connected thereto. The actuating element 330a is mounted through the top plate element 210b of the housing and is structured to drive the actuator rod 330b and stopper element 330c between a first position where the stopper element 330c is separated from the inlet of the drainage conduit and a second end where the stopper element 330c is received within the inlet of the drainage conduit to substantially prevent fluid in the cavity 340 from entering the drainage conduit.

In an embodiment, the actuator rod 330b and stopper element 330c of the actuator 330 are formed as separate, connected components. In an alternate embodiment, the actuator rod 330b and stopper element 330c of the actuator 330 are formed as parts of a continuous body.

In an exemplary embodiment, the actuating element 330a is a Round Body Air Cylinder Actuator 330, Double-Acting with ½″ Stroke Length as sourced from McMaster-Carr™. This actuator 330 is a compressed air actuator 330 that is driven to actuate by a supply of compressed air that is fed thereto. In this embodiment, the electro-amalgamation apparatus 600 comprises one or more pneumatic lines that fluidly connect the actuating element 330a and an external source of compressed gas for driving the operation of the actuating element 330a.

In an additional embodiment where the higher density layer 304 comprises mercury, the drainage assembly 350 further comprises a mercury filter 618 that is fluidly connected to the drainage conduit for filtering out mercury from the lower density layer 302 that is collected through the drainage conduit. The mercury filter 618 is capable of capturing any mercury droplets that may bypass the drainage conduit of the drainage assembly 350. The use of the mercury filter 618 after the drainage assembly 350 inhibits mercury droplets from going into the collected product lanthanide solution after actuation of the linear actuator 330 of the drainage assembly 350.

In some embodiments of the electrochemical cell housing 100 as disclosed herein, the electrochemical cell housing 100 is structured to facilitate the introduction of various species into the cavity 340 of the housing so as to control a reaction environment more precisely within the cavity 340. In one such embodiment, the cell housing is structured to further comprise an inert gas aperture 370 that is connectable to an external source of inert gas, where the inert gas is fed into the cavity 340 of the electrochemical cell housing 100 for producing a substantially inert atmosphere within the electrochemical cell 320 that is contained within the cavity 340.

In an embodiment such as shown in FIG. 3A, the top plate element 210b of the housing comprises three through-apertures. A first through-aperture of the three through-apertures is structured as the inlet 212 to allow the substrate to be introduced into the interior cavity 340 of the housing. A second through-aperture of the three through-apertures is structured as the inert gas inlet 370, and a third-through aperture of the three through-apertures is structured as a mounting aperture, where the actuator 330 of the drainage assembly 350 is connected through the mounting aperture such that stopper element 330c and at least part of the actuator rod 330b of the actuator 330 are disposed within the cavity 340 of the cell container 310.

In another additional embodiment shown in FIGS. 6 and 7, the inert gas inlet 370 of the top plate element 210b includes an inert gas adaptor tube 614 connected thereto. The inert gas adaptor tube 614 is a hollow tube which is mounted to, and which extends down from a bottom side of the top plate element 210b. The inter gas adaptor tube 614 is connected to the inert gas inlet 370 such that inert gas from the external supply of inert has will flow through the inert gas inlet 370 and along the inert gas adaptor tube 614. The inert gas adaptor tube 614 comprises at least one opening formed on a distal end thereof. The inert gas adaptor tube 614 is mounted top the top plate 644 such that the distal end of the inert gas adaptor tube 614 extends into the solution of the electrochemical cell 320 within the cavity 340, whereby that the inert gas adaptor tube 614 can then bubble the at least one inert gas into the solution for degassing the solution of the electrochemical cell 320. This may limit the extent to which the non-product lanthanide readily re-oxidizes when introduced into the solution of the electrochemical cell 320.

In an additional embodiment, at least one of the three apertures in the top plate element 210b comprises fittings that are structured to prevent leakage during fluid transfer therethrough. For example, the fittings can comprise a Luer fitting that is secured through the top plate element 210b of the electrochemical cell housing 200.

### Electro-Amalgamation Apparatus

Referring to FIGS. 6 and 7, there is provided an embodiment of the electro-amalgamation apparatus 600 of the present disclosure. In this embodiment, the electro-amalgamation apparatus 600 comprises the electrochemical cell housing 100, and the electrochemical cell 320 in the cavity 340 of the metal housing 210/cell container 310. The electro-amalgamation apparatus 600 also comprises the anode and cathode elements 602, 604 which are releasably secured in the cathode and anode holders 702, 704 mounted through the electrochemical cell housing 100. The electro-amalgamation apparatus 600 also comprises a support structure 640 that will support the various elements of the electro-amalgamation apparatus 600 and maintains the structure of the electrochemical cell 320 within the electrochemical cell housing 100.

The support structure 640 generally comprises a base plate 648 and a top plate 644 that are secured against the top and bottom ends of the electrochemical cell housing 100. The support structure 640 also comprises at least one securing element 648 (such as a clamp) that is connected between the top and base plates 644, 648 for applying a compressive force thereto such that the top and base plates 644, 648, electrochemical cell housing 100 and electrochemical cell 320 within the electrochemical cell housing 100 are held in place.

In the specific embodiment provided in FIG. 6, the support structure 640 comprises the top and base plates 644, 648 that are positioned at top and bottom ends of the electrochemical cell housing 100. The at least one securing element 648 is a pair of clamps that are connected between the top and base plates 644, 648 and which are tightened so as to apply the compressive force thereto. The support structure 640 also comprises an actuator support beam 616 that is disposed above the top plate, and a number of the support elements 642 that support that actuator support beam 616 on the base plate 648. The actuator 330 is connected to the actuator support beam 616 and is supported thereon. The external power supply 660 is provided separate from the support structure. In this embodiment, each of the top and base plates 644, 648 are flat structural plates, plurality of support elements 642 are connected between the top and base plates 644, 648 so as to support the plates in a spaced apart relationship. The fluid driving element 610 of the electro-amalgamation apparatus 600 is mounted to the base plate 648 of the support structure 640 and is positioned to direct air towards the electrochemical cell housing 100.

Referring again to the specific embodiment provided in FIGS. 6 and 7, the electro-amalgamation apparatus 600 also comprises a collection vessel 612 that is fluidly connected to the drainage assembly 350 for collecting the at least one product. In this embodiment, the support structure 640 comprises a bottom plate 646 that is connected to the base plate 648 by additional support elements 642 and is positioned below the base plate 648. In this way, the collection vessel 612 is disposed below the electrochemical cell 320 for collecting purified product lanthanide that is produced during the operating of the electro-amalgamation apparatus 600. The collection vessel 612 is fit with the mercury filter 618, and the drainage assembly 350 of the electrochemical cell housing 100 is aligned with the collection vessel 612 such that the product lanthanide can be drained into the collection vessel 612.

In an additional embodiment, each of the top, base, and bottom plates 644, 646, 648 are composed of polyethylene and are sized to be ½″ thick. The support elements 642 are a plurality of metal posts that are secured to the top, base, and bottom plates 644 or the actuator support beam 616 via a number of connecting brackets.

Various aspects of the electro-amalgamation apparatus 600, including some or all of the support structure 640, and some of the collection vessel 612 can be composed of plastic. These plastic components can be fabricated by 3-d printing or by other known plastic forming processes.

In an embodiment such as shown in FIGS. 6 and 7, the electro-amalgamation apparatus 600 also comprises a controller 650 that is operably connected to the drainage assembly 350 and that is operably connectable to the external power supply 660 for controlling a reaction of the substrate in the electrochemical cell 320 to make the at least one product. The controller 650 of the electro-amalgamation apparatus 600 is programmed to control the operation of various aspects of the electro-amalgamation apparatus 600. In the specific embodiment provided in FIGS. 6 and 7, the controller 650 is operably connected to the external power supply 660, the actuator 330, the fluid driving element 610 and the external inert gas supply so as to control each of these aspects of the electro-amalgamation apparatus 600. By providing a controller 650 that is connected to the actuator 330, the electro-amalgamation apparatus 600 can be controlled to automatically allow for the draining of the at least one product produced within the cell from the initial reaction solution once the reaction process within the electrochemical cell 320 is complete. By automating the drainage of the at least one product via the controller 650 programming and logic, the reproducibility of the reaction and separation of the product and non-product lanthanide within the electro-amalgamation apparatus 600 is improved. Using the controller 650 of the electro-amalgamation apparatus 600, various aspects of the operation of the electrochemical cell 320 within the electro-amalgamation apparatus 600 can be tailored depending on the properties of the at least one product that needs to be separated.

In an additional embodiment, the electro-amalgamation apparatus 600 can include, or can be coupled to a liquid handling system to automate other aspects of the operation of the electro-amalgamation apparatus 600.

In some embodiments of the electro-amalgamation apparatus 600, the external power supply 660 is a single power supply that is connected to both the anode and the cathode, while in other embodiments the external power supply 660 comprises at least two separate power supply units, and each of the anode and cathode is connected to a separate one of said at least two separate power supply units.

In an embodiment where the electrochemical cell housing 100 is the electrochemical cell housing 300, the electrochemical cell housing 300 can be structured as a glass wall housing.

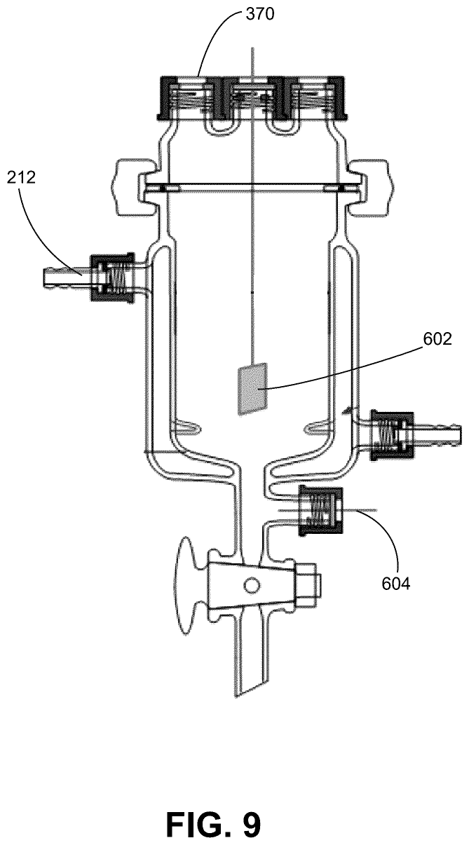

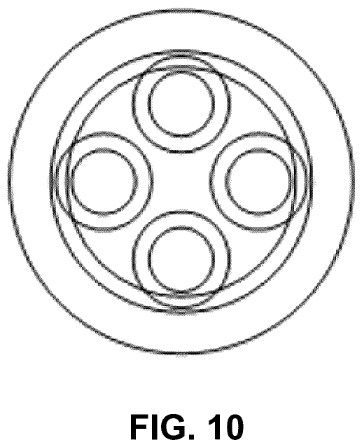

Referring to FIGS. 9 and 10, there is provided an embodiment of a water-cooled, electro-amalgamation apparatus. The water-cooled, electro-amalgamation apparatus includes a housing unit that is composed of a glass material and that includes a plurality of inlets formed in a top end of the housing unit, an outlet formed in the bottom end of the housing unit, a main internal cavity that is defined within the housing unit, at least one coolant chamber that is formed between the main internal cavity and an outer wall of the housing unit, and at least one cooling inlet and at least one cooling outlet that are connectable to an external source of a coolant and which are in fluid connection with the at least one coolant chamber for circulating the coolant therethrough to cool the main internal cavity of the housing unit, an anode element that is mounted through the housing unit such that the anode element is disposed within the main internal cavity of the housing unit, a cathode element that is mounted through the housing unit such that the cathode element is disposed in the outlet of the housing unit, and a control valve that is mounted to the outlet of the housing unit, downstream of the cathode element for controlling the flow of at least one solution within the main internal cavity out the outlet of the housing unit.

### Method of use for the Electro-Amalgamation Apparatus

The present disclosure also provides for a method of using the electro-amalgamation apparatus 600 for separating the product lanthanide and non-product lanthanide. The method comprises the steps of: combining the product lanthanide and the non-product lanthanide in the reaction solution to form the initial reaction solution, introducing the initial reaction solution into the electrochemical cell 320 of the electro-amalgamation apparatus 600 (thereby forming the primary reaction solution), and operating the electrochemical cell 320 for separating the primary reaction solution into the non-product lanthanide and a product solution that comprises the product lanthanide. The method also comprises a step of collecting a lower density layer 302 of the at least two layers of the electrochemical cell 320 that is less dense than the other layers of the at least two layers, wherein the lower density layer 302 of the at least two layers comprises the product solution with the product lanthanide.

By utilizing the above-described method when operating the electro-amalgamation apparatus 600, the apparatus as disclosed herein can perform an automated de-bulking electro-amalgamation step for separating the non-product lanthanide to provide the solution with the product lanthanide, and the non-product lanthanide amalgam. The electro-amalgamation apparatus 600 as disclosed herein is capable of processing gram quantities of non-product lanthanide and sub-milligram quantities of product lanthanide material for the separation of the product lanthanide and non-product lanthanide, while also reducing the volume of solvent and radioactive waste produced during the separate of the product and non-product lanthanides.

An exemplary embodiment of the assembly and operation of the electro-amalgamation apparatus 600 will now be described. In assembling the electro-amalgamation apparatus 600, the stopper element 330c connected to the actuator rod 330b is placed in the cavity 340 of the cell container 310 to seal the draining conduit. The cathode holder 704 and cathode element 604 are then mounted through the electrochemical cell housing 100 such that the cathode element 604 is disposed in the cavity 340. Similarly, the anode holder 702 and anode element 602 are mounted through the electrochemical cell housing 100 such that the anode element 602 is disposed in the cavity 340 of the cell container 310, above the cathode element 604. The electrochemical cell housing 100 is then placed on the support structure 640. A volume of mercury is introduced into the cavity 340 (without contacting the anode element 602) to form at least part of the higher density layer 304 of the at least two layers of the solution. The electrochemical cell housing 100 is then secured via the at least one securing element 648, and the external inert gas supply is connected to the electrochemical cell housing 100 via the inert gas inlet 370 while the anode and cathode elements 602, 604 are connected to the external power supply 660. The external power supply 660 is then connected to the controller 650.

A predetermined volume of the non-product lanthanide is combined with a corresponding of a compound that comprises the product lanthanide for forming the initial reaction solution. The initial reaction solution is diluted with water and a pH of the initial reaction solution is then verified. The initial reaction solution is then introduced into the internal cavity 340 of the electrochemical cell 320 and the controller 650 is turned on to execute a program for controlling the operation of the electro-amalgamation apparatus 600. The controller 650 program executes a number of commands and indicates the step that it is on throughout the process for traceability. The controller 650 operates the electro-amalgamation apparatus 600 to, amongst other steps, turn on the fluid driving element 610 for cooling the electrochemical cell housing 100, and inject inert gas into the electrochemical cell housing 100 for purging the primary reaction solution. The current of the external power supply 660 is then turned on. The power supply is set to potentiostatic 9V and galvanostatic 1.6A (The voltage is fixed but should the current exceed 1.6 A, it can reduce the voltage). The controller 650 then shuts off the fluid driving element 610 and the external power supply 660. The electro-amalgamation apparatus 600 has generated the at least one product from the primary reaction solution within the electrochemical cell 320. The controller 650 then operates the drainage assembly 350 to collect the at lower density layer 302 from the cavity 340 of the cell container 310 where the cavity 340 comprises the at least one product. The controller 650 then controls the actuator 330 to reseal the drainage conduit of the drainage assembly 350 such that the product lanthanide resides substantially in the collection vessel 612 and the majority of the non-product lanthanide remains substantially in the cavity 340 of the cell container 310 in the mercury, to be optionally recovered later.

In an embodiment, the external power supply 660 is configured to provide a potential difference between the anode element 602 and the cathode element 604 in a range from 6-12V. In additional embodiment, the external power supply 660 is specifically configured to provide a potential difference in a range from 8 to 9V. Applying a potential difference that is below this range was found to cause the formation of more residue during the electro-amalgamation process, and thereby resulted in a lower amount of non-product lanthanide being removed. Higher potentials were also found to not always improve the removal amount. Voltages above 12 V can result in the removal of the non-product lanthanide at too rapid a rate such that the non-product lanthanide within the amalgam can interfere with the current flow. 8-12 V are possible for the process at the 1-gram scale, but lower voltages in the range from about 8 to 9 V are preferred.

In the electro-amalgamation apparatus 600, the runtime and/or drain time of the electro-amalgamation apparatus 600 may impact the removal rate of the non-product lanthanide and the resulting purity of the product lanthanide that is extracted. Example 8 provides a description of the impact of time of operation on the resulting removal rate of the non-product lanthanide. Generally, a higher removal rate of the non-product lanthanide is achieved if the electro-amalgamation apparatus 600 is operated for a longer time, up to a maximum value that depends on the specifics of the electrochemical cell 320.

In the electro-amalgamation apparatus 600 where the apparatus 600 includes one of the electrochemical housing 200 or the electrochemical housing 400, the at least one layer 230 with at least one polymer can provide for better equilibrating of the temperature of the electrochemical cell 320. Higher masses of non-product lanthanide may need additional alkali metal salt solution and therefore have a higher starting current, thereby increasing the temperature in the electrochemical cell 320. The electrochemical cell 320 that includes either the electrochemical cell housing 200 or the electrochemical cell housing 400 may, in particular embodiments, be capable of equilibrating below about 30 degrees Celsius at a 1-gram scale.

The results of a number of exemplary runs of the electro-amalgamation apparatus 600 of the present disclosure are provided in Examples 6 and 7 of the present disclosure. Example 6 provides a number of runs of the electro-amalgamation apparatus 600 where the electro-amalgamation apparatus has doped radioactivity, while Example 7 provides a number of runs of the electro-amalgamation apparatus 600 with no radioactivity.

### Method of Separating a Product Lanthanide and Non-Product Lanthanide

The present disclosure also provides for a method of separating a product lanthanide and a non-product lanthanide, the method comprises: providing an electrochemical cell 320 that has a solution comprising at least two layers, each of the at least two layers having different densities, and introducing the product lanthanide and the non-product lanthanide into the solution of the electrochemical cell 320. The method also comprises the steps of operating the electrochemical cell 320 for separating the non-product lanthanide and a product that comprises the product lanthanide and collecting a lower density layer 302 of the at least two layers of the solution of the electrochemical cell 320, where the lower density layer 302 of the at least two layers comprises the product solution with the product lanthanide.

In an embodiment, the step of operating the electrochemical cell 320 to separate the product and non-product lanthanides is an electro-amalgamation step that produces the at least one product from the primary reaction solution within the electrochemical cell 320.

In an embodiment, the product lanthanide and the non-product lanthanide are introduced into the solution of the electrochemical cell 320 in the form of a solution.

In an alternate embodiment, the product lanthanide and the non-product lanthanide are introduced into the solution of the electrochemical cell 320 in the form of a mixture.

In an embodiment, the electrochemical cell 320 is structured such that the electro-amalgamation process operates on the non-product lanthanide in the primary reaction solution, not the product lanthanide, and therefore occurs independently of the ratio of product lanthanide to non-product lanthanide (but is dependent on the mass of non-product lanthanide present present). This results in a substantial improvement over chromatographic methods, where changes in product/non-product lanthanide ratios due to different neutron irradiation conditions can result in batch failures.

In an embodiment, the method of separating the of the product and non-product lanthanides comprises at least one neutron irradiation step where the substate that comprises the product and non-product lanthanides is irradiated prior to the introduction of the substrate into the electrochemical cell housing 100.

In an additional embodiment, the method of separating the of the product and non-product lanthanides comprises at least one dissolution step where the substate that comprises the product and non-product lanthanides is dissolved in at least one acidic solution prior to the introduction of the substrate into the electrochemical cell housing 100 such that the initial reaction solution comprises the acidic solution and the product and non-product lanthanides.

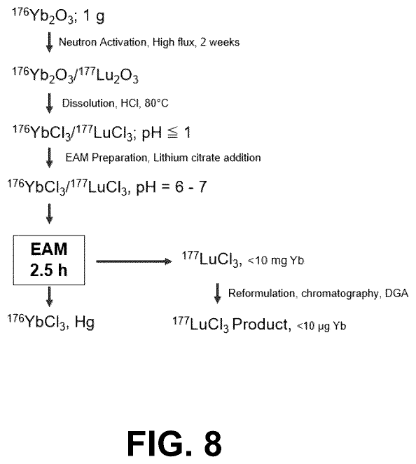

In an exemplary embodiment where the product lanthanide is Lu-177 and the non-product lanthanide is ytterbium 176, the at least one neutron irradiation step involves the irradiation of Yb-176 oxide in a nuclear reactor within an appropriate vessel for a calculated amount of time to generate ytterbium-177 upon neutron capture, which decays to Lu-177 (base on the process shown in FIG. 8).

An exemplary embodiment of a method for completing the at least one neutron irradiation step is provided in Example 1.

While the above example is specific to the irradiation of Yb-176, various other ytterbium-based compounds, such as ¹⁷⁶Yb₂O₃, ¹⁷⁶YbCl₃, ¹⁷⁶YbOCl, ¹⁷⁶Yb(NO₃)₃ can be utilized as a target for neutron irradiation in the above-described nuclear reactor. Ultimately, ¹⁷⁶Yb₂O₃ is optimal given that radiolysis can convert the other three compounds into the oxide. The remaining three compounds have a much higher solubility with water and would have sped up the dissolution process had it not been for the losses from oxide formation.

In an additional exemplary embodiment where the product lanthanide is Lu-177 and the non-product lanthanide is ytterbium 176, the at least dissolution step involves the Yb-176 is removed from the nuclear reactor, reconstituted in hydrochloric acid solution with heating, and transferred to a solution of lithium citrate so as to form the primary reaction solution. In this embodiment, the primary reaction solution has a pH in a range from about 6.5 and about 7.5. The pH of the alkali metal salt solution impacts the electro-amalgamation reaction process. When the pH was above about 7.5, Yb-176 removal may tend to be below about 90% and Lu-177 recovery may also be reduced (lost as ¹⁷⁷Lu(OH)₃, which precipitates out and is removed with the mercury in the higher density layer 304). When the pH is low (<about 5), little or no Yb-176 removal may occur, as a lower pH results in a larger availability of protons that can be reduced by electrons at the cathode, impeding the removal of Yb-176.

An exemplary embodiment of a method for completing the at least one dissolution step is provided in Example 2.

In an embodiment, the method for separating the product lanthanide and the non-product lanthanide comprises one or more steps for further purification and formulation of a product lanthanide solution substantially free of impurities (e.g., one or more of the non-product lanthanide, mercury, and trace metal(s) from the process, including, but not limited to, transition metal(s) (e.g. iron, zinc, copper, and lead)).

In an embodiment, the method of separating the of the product and non-product lanthanides comprises a first product reformulation step where the product solution that comprises the product lanthanides is reformulated after the extraction/collection of the lower density layer 302.

In an additional embodiment, the method of separating the product and non-product lanthanides comprises at least one chromatographic purification step where the product solution that has been reformulated in said at least one reformulation step is chromatographically purified.

In an additional embodiment, the method of separating the product and non-product lanthanides comprises a second reformulation step where the chromatographically purified product that comprises the product lanthanides is reformulated via resin cartridges after the extraction/collection of the lower density layer 302. Various resin cartridges can be used in this second reformulation step and in other aspects of the method as disclosed herein. For example, the resin cartridges may comprise a 50-200 μm DGA cartridge as produced by Eichrom Technologies Inc. and a 50-200 μm LN₂ cartridge as produced by Eichrom Technologies Inc.

In another additional embodiment, the method of separating the product and non-product lanthanides comprises a product recovery step after the extraction/collection of the lower density layer 302.

In an exemplary embodiment where the product lanthanide is Lu-177 and the non-product lanthanide is ytterbium 176, the first product reformulation step comprises reformulating the product solution (i.e., a citrate solution of Lu-177) using LN₂ and DGA cartridges. Lu and Yb are trapped on LN₂ and then washed off with a stronger acid onto DGA. Lu and Yb are trapped on DGA and then washed off in dilute acid suitable for chromatography. This step can be automated or done manually. In this exemplary embodiment, the product solution contains a relatively high concentration of lithium citrate that can act as a chelate and affect the subsequent chromatography steps. This step removes the citrate and converts the at least one product into a form that allows for chromatography.

An exemplary embodiment of a method for completing the first reformulation step is provided in Example 3.

In an exemplary embodiment where the product lanthanide is Lu-177 and the non-product lanthanide is ytterbium 176, the at least one, the at least one chromatographic purification step comprises the loading of an LN₂ column (25-30 cm length) with the product solution (i.e., the lithium citrate solution of Lu-177), where the product solution is washed with 1.3-1.5M HNO₃ to remove residual ytterbium, and eluted with concentrated (2-4M) HNO₃ to obtain a purified form of the lutetium. With the citrate removed, chromatography on the LN₂ column length is then completed.

An exemplary embodiment of a method for completing the chromatographic purification step is provided in Example 4.

In an exemplary embodiment where the product lanthanide is Lu-177 and the non-product lanthanide is ytterbium 176, the second reformulation step comprises reformulating the 177: nitric acid solution in dilute HCl using a 1 mL DGA cartridge. The solution is subsequently evaporated to dryness and brought up in a minimum volume of 0.05M HCl to obtain the formulated, purified at least one product.

In an exemplary embodiment where the product lanthanide is Lu-177 and the non-product lanthanide is ytterbium 176, the at least one recovery step involves leaving Ytterbium-175 and -169 within the enriched ytterbium target in the mercury amalgam to decay to acceptable levels before carrying out the recovery process. In a separatory funnel, washes are performed with 6M HCl to extract the enriched Yb-176. The extracts are evaporated to dryness and reformulated in 0.8 M oxalic acid, causing ytterbium to precipitate as the oxalate. The ytterbium oxalate is washed repeatedly with water, dried, and converted to the oxide at about 750° C.

An exemplary embodiment of a method for completing the at least one recovery step is provided in Example 5.

In an additional embodiment where the product lanthanide is Lu-177 and the non-product lanthanide comprises Yb-176, the processing of the Yb-176 non-product involves neutron irradiation, dissolution, an electro-amalgamation to remove most of the ytterbium from the Lu-177, reformulation, chromatography, and a final reformulation. The Lu-177 can then be used or distributed and the Yb-176 in mercury can be recycled and irradiated again.

In other embodiments, there is provided as follows:
Embodiment 1. An electrochemical cell housing, comprising: a metal housing having at least one layer on an interior surface thereof; wherein at least one of said at least one layer comprises at least one polymer.
Embodiment 2. An electrochemical cell housing, comprising: a cell container that defines a cavity; an inlet for introducing into the cavity, a substrate for making at least one product; and a drainage assembly; wherein at least a portion of the drainage assembly is positioned within the cavity of the housing for selectively collecting the at least one product from the cavity.
Embodiment 3. An electrochemical cell comprising the electrochemical cell housing of embodiment 1.
Embodiment 4. An electro-amalgamation apparatus comprising the electrochemical cell of embodiment 1 or 3.
Embodiment 5. The electrochemical cell housing of embodiment 1, wherein the at least one polymer of said at least one layer comprises an insulating polymer for inhibiting any reaction of the metal housing.
Embodiment 6. The electro-amalgamation apparatus of embodiment 4, further comprising a fluid driving element that is structured to pass cooled air over the electrochemical cell housing for cooling the electrochemical cell that is held within the electrochemical cell housing.
Embodiment 7. The electrochemical cell housing of embodiment 1 or 5, wherein the metal housing comprises at least two apertures, a first aperture of the at least two apertures being structured for introducing a reaction solution into the metal housing, and a second aperture of the at least two apertures being structured for collecting at least one product from the electrochemical cell.
Embodiment 8. The electro-amalgamation apparatus of embodiment 4 or 6, wherein the metal housing comprises at least one metal material.
Embodiment 9. The electro-amalgamation apparatus of embodiment 8, wherein the at least one metal material comprises metal(s), metal alloy(s), or a combination thereof.
Embodiment 10. The electro-amalgamation apparatus of embodiment 8 or 9, wherein the at least one metal material comprises aluminum, steel, or a combination thereof.
Embodiment 11. The electro-amalgamation apparatus of any one of embodiments 8 to 10, wherein the at least one metal material has a thermal conductivity exceeding 30 W/mK.
Embodiment 12. The electrochemical cell housing of any one of embodiments 1, 5 or 7, wherein the metal housing comprises: a metal, hollow, substantially cylindrical cell body; a top housing plate that is connected to a first end of the cell body; and a bottom housing plate that is connected to a second end of the cell body opposite the first end of the cell body.
Embodiment 13. The electrochemical cell housing of embodiment 5, wherein the insulating polymer comprises at least one of an epoxy, a silicone, a polyethylene, a polypropylene, a polyethylene terephthalate, a fluoropolymer, or a combination thereof.
Embodiment 14. The electrochemical cell housing of embodiment 13, wherein the insulating polymer is any polymer exhibiting high dielectric performance.
Embodiment 15. The electro-amalgamation apparatus of any one of embodiments 4, 6 or 8, wherein the electrochemical cell comprises an electrochemical cell solution that is held within the cavity of the electrochemical cell housing and that comprises at least two layers that each have different densities.
Embodiment 16. The electro-amalgamation apparatus of embodiment 15, wherein the electrochemical cell further comprises:
an anode element that is connectable to an external power supply and that is coupled to the electrochemical cell housing; and
a cathode element that is connectable to the external power supply and that is coupled to the electrochemical cell housing.
Embodiment 17. The electro-amalgamation apparatus of embodiment 16, wherein the anode element is removably mounted to the electrochemical cell housing via a holder that is fixedly mounted through the electrochemical cell housing.
Embodiment 18. The electro-amalgamation apparatus of embodiment 16 or 17, wherein the anode element comprises a metallic mesh.
Embodiment 19. The electro-amalgamation apparatus of any one of embodiments 16 to 18, wherein the cathode element is removably mounted to the electrochemical cell housing via a holder that is fixedly mounted through the electrochemical cell housing.
Embodiment 20. The electro-amalgamation apparatus of any one of embodiments 16 to 19, wherein the cathode element comprises at least one metallic wire.
Embodiment 21. An electrochemical cell comprising the electrochemical cell housing of embodiment 2.
Embodiment 22. An electro-amalgamation apparatus comprising the electrochemical cell of embodiment 21.
Embodiment 23. The electrochemical cell of embodiment 21, wherein the substrate is in the form of a solution.
Embodiment 24. The electro-amalgamation apparatus of embodiment 22, wherein the electrochemical cell comprises an electrochemical cell solution that is held within the cavity of the electrochemical cell housing and that comprises at least two layers that each have different densities.
Embodiment 25. The electro-amalgamation apparatus of embodiment 24, wherein the drainage assembly is coupled to the cell container of the electrochemical cell for selectively collecting a lower density layer of the at least two layers.
Embodiment 26. The electro-amalgamation apparatus of embodiment 24 or 25, further comprising
an anode element that is connectable to an external power supply and that is coupled to the cell container such that the anode element is at least partially disposed within a lower density layer of the at least two layers; and a cathode element that is connectable to the external power supply and that is coupled to the cell container such that the cathode element is at least partially disposed within a higher density layer of the at least two layers.
Embodiment 27. The electro-amalgamation apparatus of embodiment 26, wherein the anode element is removably mounted to the cell container via a holder that is fixedly mounted through the cell container.
Embodiment 28. The electro-amalgamation apparatus of embodiment 26 or 27, wherein the anode element comprises a metallic mesh.
Embodiment 29. The electro-amalgamation apparatus of any one of embodiments 26 to 28, wherein the cathode element is removably mounted to the cell container via a holder that is fixedly mounted through the cell container.
Embodiment 30. The electro-amalgamation apparatus of any one of embodiments 26 to 29, wherein the cathode element comprises a metallic wire.
Embodiment 31. The electro-amalgamation apparatus of any one of embodiments 22, 24 or 25, wherein the drainage assembly comprises a drainage conduit that mounted through the cell container such that an inlet of the drainage conduit is disposed in the lower density layer of the at least two layers of the electrochemical cell solution.
Embodiment 32. The electro-amalgamation apparatus of embodiment 31, wherein the drainage assembly further comprises an actuator that is operably connected to the drainage conduit and that is actuatable to selectively close and open the drainage conduit for collecting at least the lower density layer of the at least two layers.
Embodiment 33. The electro-amalgamation apparatus of embodiment 31 or 32, wherein the higher density layer of the at least two layers comprises mercury.
Embodiment 34. The electro-amalgamation apparatus of embodiment 31, wherein the drainage assembly further comprises a mercury filter that is fluidly connected to the drainage conduit for filtering out mercury from the lower density layer that is collected through the drainage conduit.
Embodiment 35. The electro-amalgamation apparatus of any of embodiments 22 and 24 to 35, wherein the cell container further comprises an inert gas aperture that is connectable to an external source of inter gas for producing a substantially inert atmosphere within the electrochemical cell.
Embodiment 36. The electro-amalgamation apparatus of any of embodiments 22 and 24 to 35, further comprising a collection vessel that is fluidly connected to the drainage assembly for collecting the at least one product.
Embodiment 37. The electro-amalgamation apparatus of any of embodiments 22 and 24 to 35, further comprising an anode element that is connectable to an external power supply and that is at least partially disposed within the cavity of the cell container; and a cathode element that is connectable to the external power supply and that is at least partially disposed within the cavity of the cell container; and a controller that is operably connected to the drainage assembly and that is operably connectable to the external power supply for controlling a reaction of the substrate in the electrochemical cell to make the at least one product.
Embodiment 38. A method of using the electro-amalgamation apparatus of any of embodiments 22 and 24 to 35 for separating a product lanthanide and a non-product lanthanide, the method comprising combining the product lanthanide and the non-product lanthanide in the reaction solution; introducing the reaction solution into the electrochemical cell of the electro-amalgamation apparatus; operating the electrochemical cell for separating the reaction solution into the non-product lanthanide and a product solution that comprises the product lanthanide; and collecting a lower density layer of the at least two layers of the electrochemical cell that is less dense than the other layers of the at least two layers; wherein the lower density layer of the at least two layers comprises the product solution with the product lanthanide.
Embodiment 39. The electro-amalgamation apparatus of any of embodiments 22 and 24 to 35, wherein the cell container is a metal housing having at least one layer on an interior surface thereof; and wherein at least one of said at least one layer comprises at least one polymer.
Embodiment 40. The electro-amalgamation apparatus of embodiment 39, wherein the at least one polymer of said at least one layer comprises an insulating polymer for inhibiting any reaction of the metal housing.
Embodiment 41. The electro-amalgamation apparatus of any of embodiments 22 and 24 to 35, further comprising a fluid driving element that is structured to pass cooled air over the electrochemical cell housing for cooling the electrochemical cell.
Embodiment 42. The electro-amalgamation apparatus of embodiment 39 or 40, wherein the metal housing comprises: a metal, hollow, substantially cylindrical cell body; a top housing plate that is connected to a first end of the cell body; and a bottom housing plate that is connected to a second end of the cell body opposite the first end of the cell body.
Embodiment 43. The electro-amalgamation apparatus of embodiment 40, wherein the insulating polymer comprises at least one of an epoxy, a silicone, a polyethylene, a polypropylene, a polyethylene terephthalate, a fluoropolymer, or a combination thereof.
Embodiment 44. The electro-amalgamation apparatus of embodiment 40 or 43, wherein the insulating polymer comprises at least one polymer exhibiting high dielectric performance.
Embodiment 45. The method of embodiment 38, wherein the product lanthanide is ¹⁷⁷Lu and the non-product lanthanide is ¹⁷⁶Yb.
Embodiment 46. An electro-amalgamation apparatus, comprising: an electrochemical cell that comprises: a cell container that defines a cavity; an inlet for introducing into the cavity, a substrate for making at least one product; an electrochemical cell solution that is held within the cavity and that comprises at least two layers that each have different densities; an anode element that is connectable to an external power supply and that is coupled to the cell container such that the anode element is at least partially disposed within a lower density layer of the at least two layers; and a cathode element that is connectable to the external power supply and that is coupled to the cell container such that the cathode element is at least partially disposed within a higher density layer of the at least two layers; and a drainage assembly that is coupled to the cell container of the electrochemical cell for collecting the lower density layer of the at least two layers.
Embodiment 47. A method of separating a product lanthanide and a non-product lanthanide, the method comprising: providing an electrochemical cell that has a solution comprising at least two layers, each of the at least two layers having different densities; introducing the product lanthanide and the non-product lanthanide into the solution of the electrochemical cell; operating the electrochemical cell for separating the non-product lanthanide and a product that comprises the product lanthanide; and collecting a lower density layer of the at least two layers of the solution of the electrochemical cell; wherein the lower density layer of the at least two layers comprises the product solution with the product lanthanide.
Embodiment 48. The method of embodiment 47, wherein the product lanthanide and the non-product lanthanide are introduced into the in the form of a solution.
Embodiment 49. The method of embodiment 47, wherein the product lanthanide and the non-product lanthanide are introduced into the in the form of a mixture.
Embodiment 50. The method of any one of embodiments 47 to 49, wherein the product lanthanide is ¹⁷⁷Lu and the non-product lanthanide is ¹⁷⁶Yb.

The above disclosure generally describes the present invention. A more complete understanding can be obtained by reference to the following specific examples. These examples are provided for purposes of illustration only, and are not intended to be limiting unless otherwise specified. Thus, the invention should in no way be construed as being limited to the following examples, but rather, should be construed to encompass any and all variations which become evident as a result of the teaching provided herein. The following working examples therefore, specifically point out the typical aspects, and are not to be construed as limiting in any way to the disclosure.

### EXAMPLES

The following examples are presented to enable those skilled in the art to understand and to practice embodiments of the present disclosure. They should not be considered as a limitation on the scope of the disclosure, but merely as being illustrative and representative thereof.

The examples herein describe embodiments of the disclosure and parameters that are relevant to increasing the scale of the process using the electro-amalgamation apparatus 600 for processing at least 1 g of ytterbium. Many parameters (e.g. separation efficiency, Lu-177 activity recovery) can be monitored by radiochemical techniques using solutions of ¹⁷⁵Yb-doped (half-life 4 days) ytterbium as a substitute for the target material.

Unless otherwise stated, reactions using about 100 mg of Yb were performed in a small cell for approximately 90 min (8 V) with about 10 ml of mercury and about 15 mL of about 0.25M lithium citrate solution, while reactions using about 1 g were performed in a large cell for approximately 120 min (8 V) with about 30 mL of mercury and about 100 ml of about 0.25M lithium citrate solution.

### Example 1

In this exemplary embodiment, the irradiation of the Yb-176 oxide or oxychloride within the nuclear reactor involves the steps of:
1) Preparation of about 0.05 M HNO₃.
2) Soak and rinse a glass vial with about 0.05 M HNO₃ and DI water.
3) Weigh out enriched ¹⁷⁶Yb₂O₃, dissolve by heating in about 1.1 eq. 2M HCl, transfer to a pre-weighed crucible and evaporate to dryness.
4) Bake the ¹⁷⁶YbCl₃·xH₂O in the oven at about 375 C for about 1.5 hours.
5) Reweigh the sample and calculate the yield.
6) Store ¹⁷⁶YbOCl inside a glass vial and store in a desiccator.
7) Load a quartz irradiation tube with sample and cap.
8) Wrap the tube with aluminum foil.
9) Select a site within the reactor with a suitable neutron flux to achieve the desired activity.
10) Transfer sample to operators for irradiation according to the protocols of the nuclear reactor.

Preparation of Ytterbium Oxide (¹⁷⁶Yb₂O₃) which involves the sub steps of:
1) Preparation of about 0.05 M HNO₃.
2) Soak and rinse a glass vial with about 0.05 M HNO₃ and DI water.
3) Weigh out enriched ¹⁷⁶Yb₂O₃, dissolve by heating in about 1.1 eq. 2M HCl, transfer to a pre-weighed crucible and evaporate to dryness.
4) Bake the ¹⁷⁶YbCl₃×H₂O in the oven at about 750 C for about 2 hours.
5) Reweigh the sample and calculate the yield.
6) Store ¹⁷⁶Yb₂O₃ inside a glass vial and store in a desiccator.
7) Load a quartz irradiation tube with sample and cap.
8) Wrap the tube with aluminum foil.
9) Select a site within the reactor with a suitable neutron flux to achieve the desired activity.
10) Transfer sample to operators for irradiation according to the protocols of the nuclear reactor.

¹⁷⁶Yb₂O₃ can also be purchased in this chemical form, in which case, the baking in the oven is not done; only the recovered Yb-176 is reconverted to the oxide.

### Example 2

An exemplary embodiment of a method for completing the at least one dissolution step comprises the following sub-steps:
1) The target is removed using standard operating procedures while taking dose measurements and placed in a pig of appropriate shielding.
2) The sample within the pig is transferred on a cart to the designated processing station.
3) The sample is removed and placed in the dose calibrator using tongs (Lu-177) to assess the activity.
4) About 4M HCl is added to the quartz tube (about 1.1 eq.), agitated using tongs, and left to dissolve.
5) 6.4 grams of lithium citrate solution are dissolved in about 75 mL water.
6) The dissolved Lu-177/HCl solution is quantitatively transferred to the lithium citrate solution.
7) The solution is diluted to about 100 mL.
8) pH is tested using a pH test strip (about 6.6<pH<about 7.6).
9) An aliquot is taken and diluted to determine activities of Lu-177 and Yb-175 by gamma spectrometry.

### Example 3

An exemplary embodiment of the method for completing the first reformulation step comprises the following sub-steps:
1) About 0.05 M HCl, about 4 M HNO₃, about 0.05 M HNO₃ are prepared.
2) About 2 mL LN₂ cartridge is conditioned with about 10 ml of about 0.05 M HNO₃.
3) About 2 mL DGA cartridge is conditioned with about 10 mL of about 4 M HNO₃.
4) The Lu-177 in citrate from the electro-amalgamation is loaded onto the LN₂ cartridge.
5) The cartridge is rinsed with about 10 ml of about 0.05 M HNO₃.
6) The DGA cartridge is connected to the exit of the LN₂ cartridge, and then about 4M HNO₃ is used to elute the Lu-177 from the LN₂ cartridge to the DGA cartridge.
7) The Lu-177 trapped on the DGA cartridge is washed with about 10 mL of about 4M HNO₃ and then about 1 mL of about 0.05 M HNO₃.
8) Finally, about 10 mL of about 0.05 M HCl is used to elute the Lu-177 into a plastic vial.
9) The activity is checked on the dose calibrator to determine if a high yield of Lu-177 is in the new citrate solution. A lower yield may suggest that the electro-amalgamation did not remove enough ytterbium.

### Example 4

An exemplary embodiment of the method for completing the chromatographic purification step comprises the following sub-steps:
1) About 0.05 M HNO₃, about 1.3 M HNO₃ and about 4.0 M HNO₃ are prepared.
2) A peristaltic pump is calibrated to determine if the chromatography flow rate is accurate.
3) LN₂ resin soaked in about 1 M HNO₃ for >about 2 days is used to load a chromatographic column with [about 0.7 or about 1.0 cm] and about 30 cm height.
4) About 0.05 M HNO₃ is used to condition the column and to check for leaks prior to loading the Lu-177.
5) The sample is loaded, washed with about 0.05 M HNO₃.
6) The column is eluted with [about 1.3 M or about 1.5 M HNO₃] to remove additional ytterbium.
7) Finally, about 4.0 M HNO₃ is eluted to obtain the Lu-177 product.
8) The sample is placed in the dose calibrator to assess activity prior to concentrating the sample.

As the chromatographic column employed in the process has a maximum Yb capacity of approximately ca. 10 mg, the potential for running two electro-amalgamation reactions was explored to remove extra quantities of Yb when the target mass is substantially greater than about 1 g. In contrast to previous studies, the Lu-177 citrate layer from a mock solution (about 100 mg scale) had a pH of about 4.5 and showed no further Yb removal after a second electro-amalgamation. For the second electro-amalgamation, the Lu-177 citrate from the first electro-amalgamation was loaded onto an LN₂ cartridge (about 2 mL) and washed with dilute nitric acid. The cartridge was then eluted onto about 2 mL DGA cartridge, washed with concentrated nitric acid and a small amount of about 0.05M HCl, and eluted with about 15 mL of about 0.25M lithium citrate. In this way, two electro-amalgamations starting at the 500 mg scale gave an overall recovery of Lu-177 of about 90%, with an overall removal of about 99.8% removal of Yb. These tests were performed in a glass cell. The automated electro-amalgamation apparatus 600 is capable of removing greater than approximately 99% of the ytterbium in a single run.

### Example 5

An exemplary embodiment of the method for completing the at least one recovery step comprises the following sub-steps:
1) Ytterbium-175 and-169 within the enriched ytterbium target are left to decay to acceptable levels before carrying out the recovery process.
2) About 6M HCl, about 2M HNO₃, DI water and isopropyl alcohol are prepared.
3) 3×about 10 mL of about 6M HCl are used to extract the enriched Yb-176 with a separatory funnel.
4) The extracts are evaporated to dryness such that the pH is >about 3.
5) About 0.8 M oxalic acid is used to precipitate the ytterbium as the oxalate.
6) The ytterbium oxalate is converted to the oxide in the oven at about 750° C. for about 2 hours.
7) The mercury purification continues with 2×about 10 mL H₂O rinses, 2×about 10 mL 2M HNO₃ rinses, 2×about 10 mL H₂O rinses, and 3×about 10 mL iPrOH rinses.
8) Filtering and drying of the mercury prior to storage and eventual reuse.

### Example 6

In an exemplary embodiment, the electro-amalgamation apparatus 600 has doped radioactivity, and is run for various time periods with various currents supplied by the external power supply. The rate of ytterbium removal (1 g scale) as a function of time and current in the electro-amalgamation apparatus 600 is provided in Table 1 below.

TABLE 1
Rate of ytterbium removal for electro-amalgamation
apparatus with doped radioactivity

| | | | | Volume |
|---|---|---|---|---|
| Time (h) | current (A) | citrate (M) | Yb removal (%) | recovery (%) |
| 2.5 | 1.42-1.57 | 0.22 | 99.7 | 99.7 |
| 2.5 | 1.35-1.6 | 0.22 | 99 | 90 |
| 2.5 | 1.33-1.57 | 0.22 | 92 | 99 |
| 2.5 | 1.35-1.58 | 0.22 | 99.6 | 88 |
| 2 | 1.35-1.56 | 0.22 | 98.5 | 98.5 |

### Example 7

In an exemplary embodiment, the electro-amalgamation apparatus 600 does not have doped radioactivity and is run for various time periods with various currents supplied by the external power supply. The rate of ytterbium removal (1 g scale) as a function of time and current in the electro-amalgamation apparatus 600 is provided in Table 2 below.

TABLE 2
Rate of ytterbium removal for electro-amalgamation
apparatus with no doped radioactivity

| | | | | Volume |
|---|---|---|---|---|
| Time (h) | current (A) | citrate (M) | Yb removal (%) | recovery (mL) |
| 2 | 1.30-1.55 | 0.22 | 99.2 | 100 |
| 2 | 1.28-1.52 | 0.22 | 98 | 90 |
| 2.5 | 1.13-1.52 | 0.22 | 99.5 | N/A |

### Example 8

Mock solutions were prepared at the 100 mg Yb scale, and the resulting citrate layer from the EAM was isolated at various times (see Table 3 below, which shows Ytterbium removal as a function of time in a small glass cell (ca. 100 mg Yb; not automated)). The process in this disclosure did not achieve approximately ca. 99% removal until about 90 minutes. Yb removal was consistently higher the longer the potential was applied. No substantial improvement was achieved by running the process for longer than about 90 min, owing to a small equilibrium whereby the reverse process of ytterbium reoxidation and transport back into the citrate layer occurs.

TABLE 3
Effect of time on ytterbium removal and lutetium recovery

| Yb (mg) | time (min) | Yb removal (%) | Lu-177 recovery (%) |
|---|---|---|---|
| 102.9 | 30 | 82.1 | 97.4 |
| 104.8 | 60 | 97.2 | 96.6 |
| 106.7 | 75 | 98.1 | 97.9 |
| 105.7 | 90 | 98.8 | 98.9 |
| 110.3 | 90 | 98.6 | 97.3 |
| 96.2 | 90 | 99.0 | 95.1 |
| 100.8 | 120 | 99.0 | 99.9 |

At the 1 g scale, Yb removal of approximately >98% at about 120 min (see Table 4, which shows Ytterbium removal as a function of mass in a small glass EAM cell (90 min; not automated; 15 mL water). These values are different in the automated cell with different dimensions, but the same effect holds true: Higher ytterbium removal occurs if the experiment is run for a longer time, up to a maximum value that depends on the cell.

TABLE 4
Effect of ytterbium mass on ytterbium removal
and lutetium recovery after 90 minutes

| | | | Yb removal | Lu-177 |
|---|---|---|---|---|
| Yb (mg) | current (A) | citrate (M) | (%) | recovery (%) |
| 406.1 | 0.67 | 0.4 | 91.7 | 99.9 |
| 807.1 | 0.94 | 0.6 | 88.1 | 98.9 |
| 813.4 | 0.98 | 0.6 | 91.7 | 99.9 |
| 1013.4 | 0.90 | 0.8 | 82.9 | 96.6 |
| 1624.5 | 1.03 | 1.1 | 48.8 | 96.7 |

The specific embodiments described above have been shown by way of example, and it should be understood that these embodiments may be susceptible to various modifications and alternative forms. It should be further understood that the above-described embodiments are intended to be examples of the present disclosure and alterations and modifications may be affected thereto, by those of skill in the art, without departing from the scope of the disclosure that is defined solely by the claims appended hereto.

What is claimed is:

1. An electrochemical cell housing, comprising:
a metal housing having at least one layer on an interior surface thereof;
wherein at least one of said at least one layer comprises at least one polymer.

2. An electrochemical cell housing, comprising:
a cell container that defines a cavity;
an inlet for introducing into the cavity, a substrate for making at least one product; and
a drainage assembly;
wherein at least a portion of the drainage assembly is positioned within the cavity of the housing for selectively collecting the at least one product from the cavity.

3. An electrochemical cell comprising the electrochemical cell housing of claim 1.

4. An electro-amalgamation apparatus comprising the electrochemical cell of claim 3.

5. The electrochemical cell housing of claim 1, wherein the at least one polymer of said at least one layer comprises an insulating polymer for inhibiting any reaction of the metal housing.

6. The electro-amalgamation apparatus of claim 4, further comprising a fluid driving element that is structured to pass cooled air over the electrochemical cell housing for cooling the electrochemical cell that is held within the electrochemical cell housing.

7. The electrochemical cell housing of claim 1, wherein the metal housing comprises at least two apertures, a first aperture of the at least two apertures being structured for introducing a reaction solution into the metal housing, and a second aperture of the at least two apertures being structured for collecting at least one product from the electrochemical cell.

8. The electro-amalgamation apparatus of claim 4, wherein the metal housing comprises at least one metal material.

9. The electro-amalgamation apparatus of claim 8, wherein the at least one metal material comprises metal(s), metal alloy(s), or a combination thereof.

10. The electro-amalgamation apparatus of claim 8, wherein the at least one metal material comprises aluminum, steel, or a combination thereof.

11. The electro-amalgamation apparatus of claim 8, wherein the at least one metal material has a thermal conductivity exceeding 30 W/mK.

12. The electrochemical cell housing of claim 1, wherein the metal housing comprises:
a metal, hollow, substantially cylindrical cell body;
a top housing plate that is connected to a first end of the cell body; and
a bottom housing plate that is connected to a second end of the cell body opposite the first end of the cell body.

13. The electrochemical cell housing of claim 5, wherein the insulating polymer comprises at least one of an epoxy, a silicone, a polyethylene, a polypropylene, a polyethylene terephthalate, a fluoropolymer, or a combination thereof.

14. The electrochemical cell housing of claim 13, wherein the insulating polymer is any polymer exhibiting high dielectric performance.

15. The electro-amalgamation apparatus of claim 4, wherein the electrochemical cell comprises an electrochemical cell solution that is held within the cavity of the electrochemical cell housing and that comprises at least two layers that each have different densities.

16. The electro-amalgamation apparatus of claim 15, wherein the electrochemical cell further comprises:
an anode element that is connectable to an external power supply and that is coupled to the electrochemical cell housing; and
a cathode element that is connectable to the external power supply and that is coupled to the electrochemical cell housing.

17. The electro-amalgamation apparatus of claim 16, wherein the anode element is removably mounted to the electrochemical cell housing via a holder that is fixedly mounted through the electrochemical cell housing.

18. The electro-amalgamation apparatus of claim 16, wherein the anode element comprises a metallic mesh.

19. The electro-amalgamation apparatus of claim 16, wherein the cathode element is removably mounted to the electrochemical cell housing via a holder that is fixedly mounted through the electrochemical cell housing.

20. The electro-amalgamation apparatus of claim 16, wherein the cathode element comprises at least one metallic wire.

21. An electrochemical cell comprising the electrochemical cell housing of claim 2.

22. An electro-amalgamation apparatus, comprising:
an electrochemical cell that comprises:
a cell container that defines a cavity;
an inlet for introducing into the cavity, a substrate for making at least one product;
an electrochemical cell solution that is held within the cavity and that comprises at least two layers that each have different densities;
an anode element that is connectable to an external power supply and that is coupled to the cell container such that the anode element is at least partially disposed within a lower density layer of the at least two layers; and
a cathode element that is connectable to the external power supply and that is coupled to the cell container such that the cathode element is at least partially disposed within a higher density layer of the at least two layers; and
a drainage assembly that is coupled to the cell container of the electrochemical cell for collecting the lower density layer of the at least two layers.
